(19) United States
(12) Patent Application Publication
(10) Pub. No.: US 2026/0029786 A1
(43) Pub. Date: Jan. 29, 2026

(54) EQUIPMENT FAILURE PREDICTION USING MACHINE LEARNING

(71) Applicant: Schlumberger Technology Corporation, Sugar Land, TX (US)

(72) Inventors: Kaustubh Shrivastava, Houston, TX (US); Jason Baihly, Houston, TX (US)

(21) Appl. No.: 19/278,076

(22) Filed: Jul. 23, 2025

Related U.S. Application Data
(60) Provisional application No. 63/674,811, filed on Jul. 24, 2024.

(51) Int. Cl. G05B 23/02; G06Q 50/06

(52) U.S. Cl. CPC G05B 23/0267; G05B 23/0243; G05B 23/0283; G06Q 50/06

(57) ABSTRACT

A method for predicting equipment failure at a site. The method may include receiving data related to the site by a data gathering platform and then generating a failure prediction model based on the data by a data science platform. The failure prediction model may then be deployed to the data gathering platform so that a failure prediction related to the equipment using the failure prediction model may be generated. The generated failure prediction may be displayed on a display and may include graphical visualization which assist a user in interpreting the prediction of failure. The failure prediction model may be based or trained on flowback data obtained from when a wellbore may have been established at the site and/or real-time data that has been received from equipment disposed at the site and connected to the data gathering platform.

### CROSS-REFERENCE TO RELATED APPLICATIONS

This patent application claims priority to U.S. Provisional Application No. 63/674,811, filed on Jul. 24, 2024, which is incorporated by reference herein in its entirety.

### BACKGROUND

Reference to Failure of equipment at a wellsite for obtaining hydrocarbons may be an expensive, time consuming processes as production may be reduced during repair or maintenance time. For example, choke valves are control valves used to control flow and pressure of hydrocarbons produced from oil and gas wells. Choke valves are installed on the surface near a well head location and are used to reduce or increase the flow of the hydrocarbons to surface equipment. These chokes play a role in ensuring safe operations at the surface as they help prevent surface equipment from getting overloaded and damaged during operations.

Choke valves and other equipment may be damaged over time. For example, as fluid flows from the well towards surface equipment at a high rate, it may carry with it sand particles and other lose solids from the downhole to the surface pipelines, which in turn may damage the installed equipment. This damage, over time, may result in equipment failure. A failure event may result in imbalances in the surface network flow and may lead to sudden pressure surges. These uncontrolled flow and pressure surge may damage and pose risk to the integrity of downstream equipment and pipelines.

### SUMMARY

A method is provided for predicting equipment failure at a site. The method may include receiving data related to the site by a data gathering platform, generating a failure prediction model based on the data by a data science platform, deploying the failure prediction model to the data gathering platform, generating a failure prediction related to the equipment using the failure prediction model, and displaying the generated failure prediction on a display.

Also provided is a computing system which includes one or more processors and a memory system having one or more non-transitory computer-readable media storing instructions that, when executed by at least one of the one or more processors, cause the computing system to perform operations. The operations may include receiving data related to the site by a data gathering platform, generating a failure prediction model based on the data by a data science platform, deploying the failure prediction model to the data gathering platform, generating a failure prediction related to the equipment using the failure prediction model, and displaying the generated failure prediction on a display.

Also provided is a non-transitory computer-readable medium storing instructions that, when executed by one or more processors of a computing system, cause the computing system to perform operations. The operations may include receiving data related to the site by a data gathering platform, generating a failure prediction model based on the data by a data science platform, deploying the failure prediction model to the data gathering platform, generating a failure prediction related to the equipment using the failure prediction model, and displaying the generated failure prediction on a display.

It will be appreciated that this summary is intended merely to introduce some aspects of the present methods, systems, and media, which are more fully described and/or claimed below. Accordingly, this summary is not intended to be limiting.

### BRIEF DESCRIPTION OF THE DRAWINGS

The accompanying drawings, which are incorporated in and constitute a part of this specification, illustrate embodiments of the present teachings and together with the description, serve to explain the principles of the present teachings. In the figures:

FIG. 1 illustrates an example of a system that includes various management components to manage various aspects of a geologic environment, according to an embodiment.

FIG. 2 illustrates a representation of how a plurality of features may be extracted and utilized for predicting expected failure frequency, according to an embodiment.

FIG. 3 illustrates a line graph showing a lead-time for a predicted failure event, according to an embodiment.

FIG. 4 illustrates a flowchart where a ML model may be trained for flowback data, according to an embodiment.

FIG. 5 illustrates a flowchart where a ML model may be trained for real-time data, according to an embodiment.

FIG. 6 illustrates a graphical representation of how two real time models may be used together to ensure signals from different lead-times may be captured in a single prediction, according to an embodiment.

FIG. 7 illustrates a flowchart of a method for providing a failure prediction incorporating a data science platform and a data gathering platform, according to an embodiment.

FIG. 8 illustrates a flowchart of a method for predicting equipment failure at a site, according to an embodiment.

FIG. 9 illustrates a schematic view of a computing system for performing at least a portion of the method(s) described herein, according to an embodiment.

### DETAILED DESCRIPTION

Reference will now be made in detail to embodiments, examples of which are illustrated in the accompanying drawings and figures. In the following detailed description, numerous specific details are set forth in order to provide a thorough understanding of the invention. However, it will be apparent to one of ordinary skill in the art that the invention may be practiced without these specific details. In other instances, well-known methods, procedures, components, circuits, and networks have not been described in detail so as not to unnecessarily obscure aspects of the embodiments.

It will also be understood that, although the terms first, second, etc. may be used herein to describe various elements, these elements should not be limited by these terms. These terms are only used to distinguish one element from another. For example, a first object or step could be termed a second object or step, and, similarly, a second object or step could be termed a first object or step, without departing from the scope of the present disclosure. The first object or step, and the second object or step, are both, objects or steps, respectively, but they are not to be considered the same object or step.

The terminology used in the description herein is for the purpose of describing particular embodiments and is not intended to be limiting. As used in this description and the appended claims, the singular forms “a,” “an” and “the” are intended to include the plural forms as well, unless the context clearly indicates otherwise. It will also be understood that the term “and/or” as used herein refers to and encompasses any possible combinations of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Further, as used herein, the term “if” may be construed to mean “when” or “upon” or “in response to determining” or “in response to detecting,” depending on the context.

Attention is now directed to processing procedures, methods, techniques, and workflows that are in accordance with some embodiments. Some operations in the processing procedures, methods, techniques, and workflows disclosed herein may be combined and/or the order of some operations may be changed.

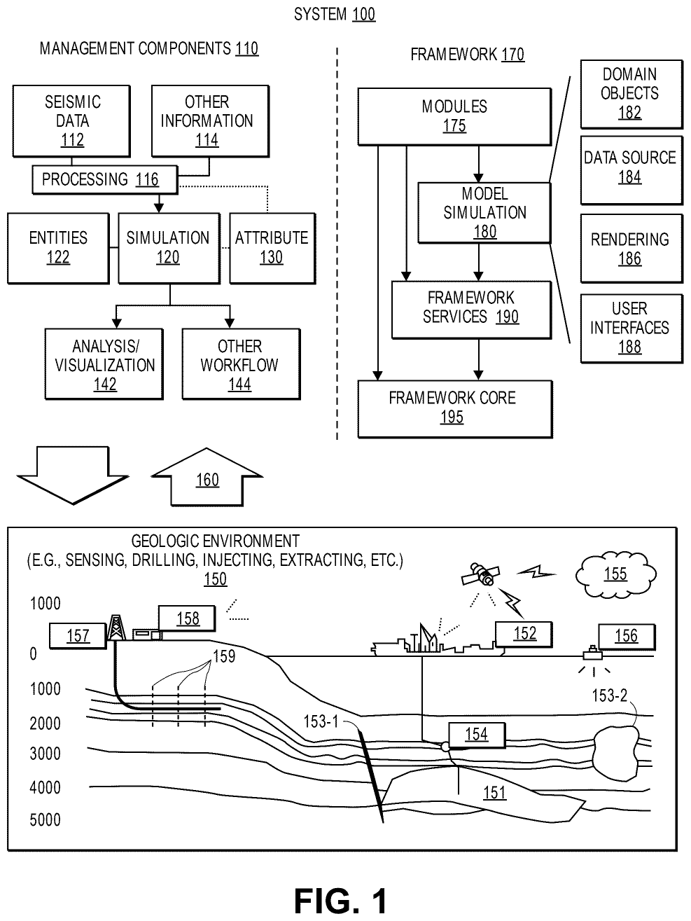

FIG. 1 illustrates an example of a system 100 that includes various management components 110 to manage various aspects of a geologic environment 150 (e.g., an environment that includes a sedimentary basin, a reservoir 151, one or more faults 153-1, one or more geobodies 153-2, etc.). For example, the management components 110 may allow for direct or indirect management of sensing, drilling, injecting, extracting, etc., with respect to the geologic environment 150. In turn, further information about the geologic environment 150 may become available as feedback 160 (e.g., optionally as input to one or more of the management components 110).

In the example of FIG. 1, the management components 110 include a seismic data component 112, an additional information component 114 (e.g., well/logging data), a processing component 116, a simulation component 120, an attribute component 130, an analysis/visualization component 142 and a workflow component 144. In operation, seismic data and other information provided per the components 112 and 114 may be input to the simulation component 120.

In an example embodiment, the simulation component 120 may rely on entities 122. Entities 122 may include earth entities or geological objects such as wells, surfaces, bodies, reservoirs, etc. In the system 100, the entities 122 may include virtual representations of actual physical entities that are reconstructed for purposes of simulation. The entities 122 may include entities based on data acquired via sensing, observation, etc. (e.g., the seismic data 112 and other information 114). An entity may be characterized by one or more properties (e.g., a geometrical pillar grid entity of an earth model may be characterized by a porosity property). Such properties may represent one or more measurements (e.g., acquired data), calculations, etc.

In an example embodiment, the simulation component 120 may operate in conjunction with a software framework such as an object-based framework. In such a framework, entities may include entities based on pre-defined classes to facilitate modeling and simulation. A commercially available example of an object-based framework is the MICROSOFT®.NET® framework (Redmond, Washington), which provides a set of extensible object classes. In the .NET® framework, an object class encapsulates a module of reusable code and associated data structures. Object classes may be used to instantiate object instances for use in by a program, script, etc. For example, borehole classes may define objects for representing boreholes based on well data.

In the example of FIG. 1, the simulation component 120 may process information to conform to one or more attributes specified by the attribute component 130, which may include a library of attributes. Such processing may occur prior to input to the simulation component 120 (e.g., consider the processing component 116). As an example, the simulation component 120 may perform operations on input information based on one or more attributes specified by the attribute component 130. In an example embodiment, the simulation component 120 may construct one or more models of the geologic environment 150, which may be relied on to simulate behavior of the geologic environment 150 (e.g., responsive to one or more acts, whether natural or artificial). In the example of FIG. 1, the analysis/visualization component 142 may allow for interaction with a model or model-based results (e.g., simulation results, etc.). As an example, output from the simulation component 120 may be input to one or more other workflows, as indicated by a workflow component 144.

As an example, the simulation component 120 may include one or more features of a simulator such as the ECLIPSE™ reservoir simulator (Schlumberger Limited, Houston Texas), the INTERSECT™ reservoir simulator (Schlumberger Limited, Houston Texas), etc. As an example, a simulation component, a simulator, etc. may include features to implement one or more meshless techniques (e.g., to solve one or more equations, etc.). As an example, a reservoir or reservoirs may be simulated with respect to one or more enhanced recovery techniques (e.g., consider a thermal process such as SAGD, etc.).

In an example embodiment, the management components 110 may include features of a commercially available framework such as the PETREL® seismic to simulation software framework (Schlumberger Limited, Houston, Texas). The PETREL® framework provides components that allow for optimization of exploration and development operations. The PETREL® framework includes seismic to simulation software components that may output information for use in increasing reservoir performance, for example, by improving asset team productivity. Through use of such a framework, various professionals (e.g., geophysicists, geologists, and reservoir engineers) may develop collaborative workflows and integrate operations to streamline processes. Such a framework may be considered an application and may be considered a data-driven application (e.g., where data is input for purposes of modeling, simulating, etc.).

In an example embodiment, various aspects of the management components 110 may include add-ons or plug-ins that operate according to specifications of a framework environment. For example, a commercially available framework environment marketed as the OCEAN® framework environment (Schlumberger Limited, Houston, Texas) allows for integration of add-ons (or plug-ins) into a PETREL® framework workflow. The OCEAN® framework environment leverages .NET® tools (Microsoft Corporation, Redmond, Washington) and offers stable, user-friendly interfaces for efficient development. In an example embodiment, various components may be implemented as add-ons (or plug-ins) that conform to and operate according to specifications of a framework environment (e.g., according to application programming interface (API) specifications, etc.).

FIG. 1 also shows an example of a framework 170 that includes a model simulation layer 180 along with a framework services layer 190, a framework core layer 195 and a modules layer 175. The framework 170 may include the commercially available OCEAN® framework where the model simulation layer 180 is the commercially available PETREL® model-centric software package that hosts OCEAN® framework applications. In an example embodiment, the PETREL® software may be considered a data-driven application. The PETREL® software may include a framework for model building and visualization.

As an example, a framework may include features for implementing one or more mesh generation techniques. For example, a framework may include an input component for receipt of information from interpretation of seismic data, one or more attributes based at least in part on seismic data, log data, image data, etc. Such a framework may include a mesh generation component that processes input information, optionally in conjunction with other information, to generate a mesh.

In the example of FIG. 1, the model simulation layer 180 may provide domain objects 182, act as a data source 184, provide for rendering 186 and provide for various user interfaces 188. Rendering 186 may provide a graphical environment in which applications may display their data while the user interfaces 188 may provide a common look and feel for application user interface components.

As an example, the domain objects 182 may include entity objects, property objects and optionally other objects. Entity objects may be used to geometrically represent wells, surfaces, bodies, reservoirs, etc., while property objects may be used to provide property values as well as data versions and display parameters. For example, an entity object may represent a well where a property object provides log information as well as version information and display information (e.g., to display the well as part of a model).

In the example of FIG. 1, data may be stored in one or more data sources (or data stores, generally physical data storage devices), which may be at the same or different physical sites and accessible via one or more networks. The model simulation layer 180 may be configured to model projects. As such, a particular project may be stored where stored project information may include inputs, models, results and cases. Thus, upon completion of a modeling session, a user may store a project. At a later time, the project may be accessed and restored using the model simulation layer 180, which may recreate instances of the relevant domain objects.

In the example of FIG. 1, the geologic environment 150 may include layers (e.g., stratification) that include a reservoir 151 and one or more other features such as the fault 153-1, the geobody 153-2, etc. As an example, the geologic environment 150 may be outfitted with any of a variety of sensors, detectors, actuators, etc. For example, equipment 152 may include communication circuitry to receive and to transmit information with respect to one or more networks 155. Such information may include information associated with downhole equipment 154, which may be equipment to acquire information, to assist with resource recovery, etc. Other equipment 156 may be located remote from a well site and include sensing, detecting, emitting or other circuitry. Such equipment may include storage and communication circuitry to store and to communicate data, instructions, etc. As an example, one or more satellites may be provided for purposes of communications, data acquisition, etc. For example, FIG. 1 shows a satellite in communication with the network 155 that may be configured for communications, noting that the satellite may additionally or instead include circuitry for imagery (e.g., spatial, spectral, temporal, radiometric, etc.).

FIG. 1 also shows the geologic environment 150 as optionally including equipment 157 and 158 associated with a well that includes a substantially horizontal portion that may intersect with one or more fractures 159. For example, consider a well in a shale formation that may include natural fractures, artificial fractures (e.g., hydraulic fractures) or a combination of natural and artificial fractures. As an example, a well may be drilled for a reservoir that is laterally extensive. In such an example, lateral variations in properties, stresses, etc. may exist where an assessment of such variations may assist with planning, operations, etc. to develop a laterally extensive reservoir (e.g., via fracturing, injecting, extracting, etc.). As an example, the equipment 157 and/or 158 may include components, a system, systems, etc. for fracturing, seismic sensing, analysis of seismic data, assessment of one or more fractures, etc.

As mentioned, the system 100 may be used to perform one or more workflows. A workflow may be a process that includes a number of worksteps. A workstep may operate on data, for example, to create new data, to update existing data, etc. As an example, it may operate on one or more inputs and create one or more results based on one or more algorithms. As an example, a system may include a workflow editor for creation, editing, executing, etc. of a workflow. In such an example, the workflow editor may provide for selection of one or more pre-defined worksteps, one or more customized worksteps, etc. As an example, a workflow may be a workflow implementable in the PETREL® software, for example, that operates on seismic data, seismic attribute(s), etc. As an example, a workflow may be a process implementable in the OCEAN® framework. As an example, a workflow may include one or more worksteps that access a module such as a plug-in (e.g., external executable code, etc.).

### Equipment Failure Prediction Using Machine Learning

Disclosed herein is a machine learning based method to predict equipment failures using real-time data and initial flowback data. Predicting failures of equipment during operations may result in enhancing operational efficiency, safety and performance. This may enable companies to take preemptive measures to avoid equipment failures and also prepare for such an event, resulting in cost savings. Also, by identifying the reasons resulting in frequent failures, the model may suggest optimized production planning and operations, and address potential equipment related issues before they lead to failure.

In one embodiment, the method uses two approaches to predict equipment failure. The approaches are based on different datasets related to equipment operations, namely flowback data and real-time data. The flowback data, or data which is collected during the initial production period of the wellbore, may include data such as a choke opening schedule and sand production information during flowback, whereas the real-time data provides information about the real-time status of the equipment such as a choke opening value, a pressure withing the wellbore, and a flowrate of hydrocarbons in the wellbore. In certain embodiments, the method may use these two datasets as a basis to extract engineered features that have high correlation with the failure frequency of the equipment. From the dataset, both qualitative and quantitative time series may be used to extract features. In certain embodiments, these features may then be used in a machine learning algorithm to predict failure of the equipment.

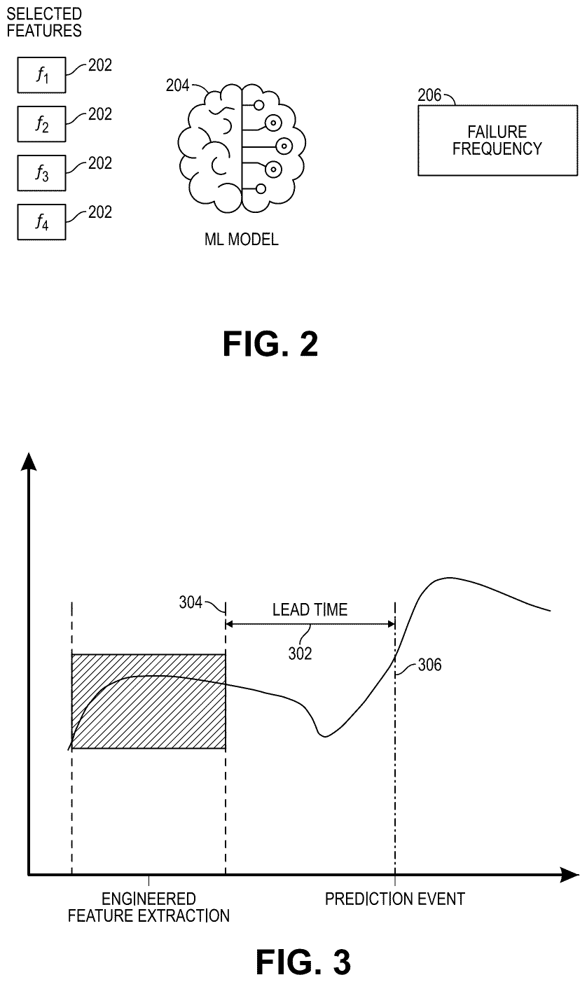

In certain embodiments and as seen in FIG. 2, a plurality of features 202 may be extracted from the flowback data and utilized for predicting expected failure frequency over the entire life of the well. The flowback data may be processed to extract features 202 that represent overall damage to the equipment, which in turn may be used in a machine learning (ML) model 204 to predict an expected average time between consecutive failures or a failure frequency 206.

In certain embodiments, features may be extracted from the real-time data and then used to predict imminent failure of the equipment. A similar process may be used to analyze flowback data, and engineered features that may be highly correlated with imminent failures. These features may be used for training an ML model that predicts imminent failure of the equipment. This may provide the production team a lead-time 302 as seen in FIG. 3 which is a period of time that may be defined as the time between feature extraction has been completed 304 to the start of the predicted event 306. The lead-time 302 allows users to prepare for such an event and convert any unplanned shutdown of the wellsite to a planned one.

According to certain embodiments, a method is provided which may reduce the operational, production, and safety risk associated with equipment failure. The method may be applied to challenges related to any of the operational equipment disposed at the site or which may be used to extract hydrocarbons from the wellbore. For example, the method may be used to predict choke failure in advance and provide guidance on choke handling in order to reduce such events during the lifetime of the well. In certain other embodiments, the method may be used to predict failure of any moving or rotating parts or components used within the wellbore or at the site. The developed workflow may in turn allow users to use data-driven models to learn from past operational practices and its impact on equipment failure frequency. In certain embodiments, the method may be used to predict failure events and improve their preparedness for such occurrences, in turn reducing the overall cost and associated safety risk.

In certain embodiments, the method may be used to design machine learning driven algorithms to predict failure of the equipment. The workflow, in one embodiment, may be a combination of two different techniques to predict equipment failures. The first technique may use flowback related data for predicting failures. This data may be collected during the initial production period of the well, where the production rate from the well is increasing as it is being brought online after completion. This change in rate of oil and gas may result in increased production of sand and other solid particles from the reservoir which may damage surface equipment. Table 1 below shows the different types of time series that are available during the flowback period for analysis. It should be noted that the specific types of time series included in Table 1 are meant to be for illustrative purposes and that additional or different types of time series may be used without departing from the original scope of the disclosure.

TABLE 1

| | | | | |
|---|---|---|---|---|
| Casing Pressure | Gas Rate | Sand Production | Well Head | Choke |
| Line Pressure | (MSCFD) | (qualitative) | Temp. (F.) | Opening |
| (PSI) | Water Production | H2S (PPM) | Water Gas Ratio | |
| Pressure Drop | Rate | CO2 (%) | (%) | |
| Bottom Hole | Cumulative Gas | Chlorides (PPM) | Load Recovery Z | |
| Pressure | Production | | Factor | |
| | Cumulative | | | |
| | Water Production | | | |

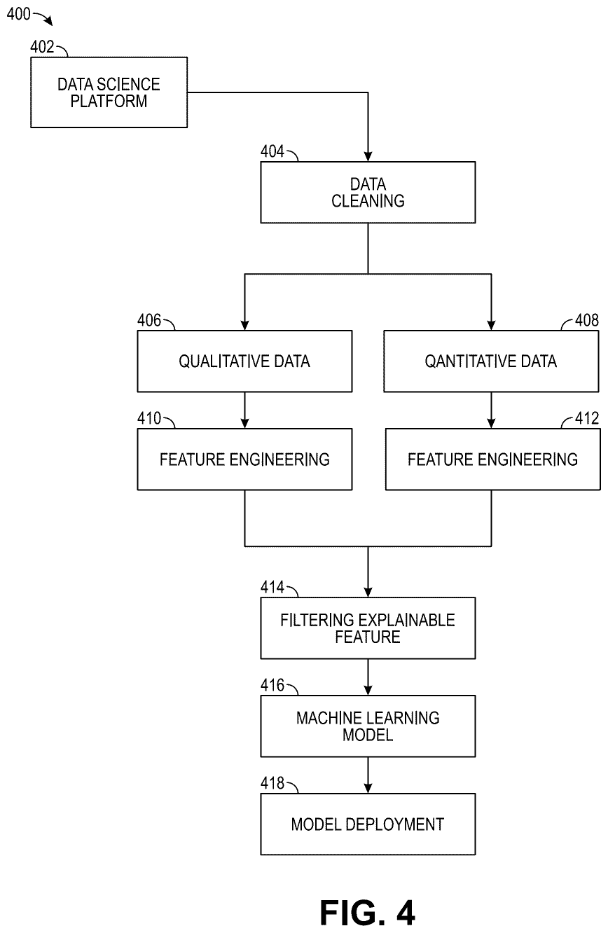

In one embodiment, a workflow 400 may be provided as seen in FIG. 4 where a ML model may be trained for flowback data. In certain embodiments, engineered features may be extracted from the time series listed in Table 1 and then used in a machine learning model to predict failure frequency of the equipment which in the embodiment shown may be a failure of a choke valve. According to certain embodiments, data received by a data science platform 402 may be cleaned as at step 404 where outliers or other erroneous entries may be removed from the received data. After cleaning and during the preparation of engineered features, in addition to quantitative data 406 or time series, qualitative data 408 or time series descriptions (such as a qualitative description of sand production with time) may be utilized to create corresponding derivative features 410, 412. In certain embodiments, the features that may be engineered from the quantitative data 406 and/or the qualitative data 408 may include an obtained parameter that is tied to a specific time or geographic location. For example, when establishing a new well, the amount of sand produced may vary according to the geologic environment that the well is being established in. The features may then be filtered as at step 414 before being used to train the machine learning model as at step 416. In certain embodiments, the features may be filtered according to their corresponding relevancy to the final output of the ML model, for example predicting a failure frequency of equipment at the wellsite. Additionally, the features may be filtered according to their relative explainability to the user. For example, a feature which may be understood by the user to have an effect on wellsite equipment may be used to train the ML model since such use would increase confidence in the results of the ML model. In contrast, a complex feature which is not understandable would not be used in training since its use may lower the amount of trust the user may place into the resulting ML model. Once trained, the ML model may be deployed as at step 418.

To illustrate the workflow 400 according to an embodiment, failure frequency data may be extracted from corresponding downtime reports at the data science platform 402 and then cleaned as at step 404 before it is used for the ML model training. In one embodiment, a subset of features may be selected from the failure frequency data that show high correlation with failure frequency which may be then used in training the ML model as at step 416 to, for example, create a supervised learning model using past failure data. This created ML model may then be tested on unseen data to validate the prediction capability of the model. In one embodiment, the features may be engineered as at steps 410, 412 in a way to maintain the explainability of the machine learning model and their correlation with failure. The engineered features may provide a clear association between the operational practices and resulting equipment failure frequency, indicating that operational behavior early in the life of the well may alter the equipment of the well that then gets manifested in frequency of failure events associated with the equipment. For example, features extracted from sand production behavior may also show a tight correlation with the failure frequency of the choke, further improving the confidence that initial operational practice may impact sand production behavior that in turn determine the overall failure frequency of the choke.

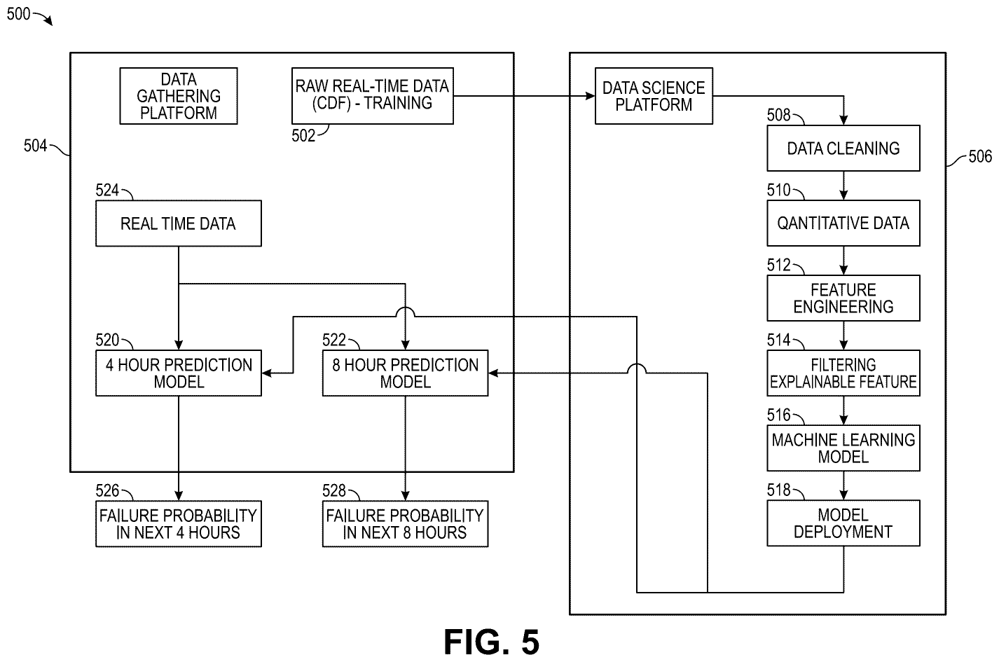

In certain embodiments, a workflow 500 as seen in FIG. 5 may be provided where real time data may be used to predict imminent failure events during operation. For example, raw real-time training data 502 may be obtained at a data gathering platform 504 from the wellbore or related equipment disposed at the site which may then be sent to a data science platform 506. The data science platform 506 may clean the real-time training data as at 508. After cleaning and during the preparation of engineered features, quantitative data may be extracted as at 510 and then may be utilized to create corresponding derivative features as at 512. Such features may be filtered as at 514 before being used to train the machine learning model as at 516. In certain embodiments, the engineered features may be designed by accounting for their respective correlations with failure events occurring with a lead-time based on known past data. Once trained, the ML model may be deployed as at 518 and sent back to the data gathering platform 504. In certain embodiments, the data gathering platform 504 may be disposed at the same site of the equipment providing the raw real-time training data 502. For example, the data gathering platform 504 may be part of a suite of edge devices or part of the system 100 illustrated in FIG. 1. In certain embodiments, the data gathering platform 504 may be connected to the site and the wellsite equipment remotely through a Cloud infrastructure or other suitable network connection.

According to certain embodiments, multiple sets of lead-time may be selected as signals associated with different time series. For example, multiple high correlation engineered features may be used simultaneously by the machine learning model to achieve high accuracy. In one embodiment, the data science platform 506 may be used within the workflow 500 to provide multiple models that may be deployed in the data gathering platform 504 to leverage its high efficiency design for processing time-series and in real-time process and predict a probability of failure events. In certain embodiments, the data science platform 506 may provide a 4-hour prediction model 520 and an 8-hour prediction model 522, thereby providing a probability of equipment failure for a given 4-8 hour window, according to an embodiment. It should be noted that the specific 4-hour and 8-hour time frames for the prediction models 520, 522 are meant to be for illustrative purposes only and that the deployment of the trained ML model(s) as at 518 may include different or additional time frames or windows that are not explicitly stated herein. As further seen in FIG. 5, both the 4-hour prediction model 520 and the 8-hour prediction model 522 may receive new, raw real-time data 524 from the site or the equipment disposed at the site. The 4-hour prediction model 520 and the 8-hour prediction model 522 may then use the real-time data 524 to provide or generate a probability of the equipment failing within the next four hours 526 and a probability of the equipment failing within the next eight hours 528, respectively. In certain embodiments, the generated probabilities may be incorporated into a graphical interface and displayed on a display for the user. In certain embodiments, the display may a part or form a portion of the system 100 of FIG. 1.

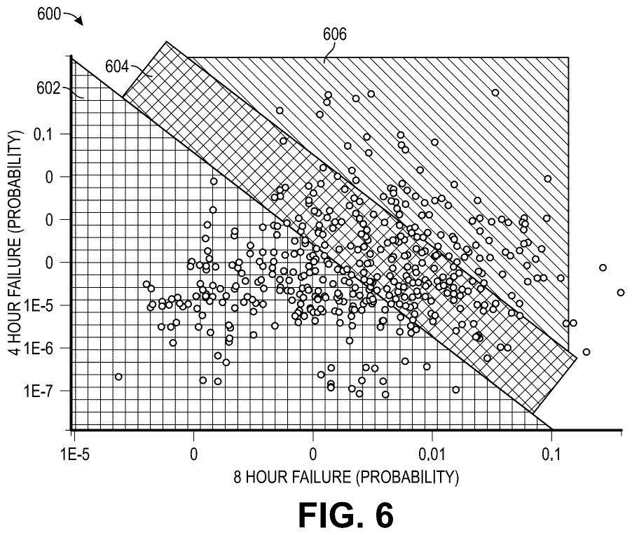

FIG. 6 illustrates how two real time models, for example the 4-hour prediction model 520 and the 8-hour prediction model 522, may be used together to ensure signals from different lead-times may be captured in a single prediction 600, according to an embodiment. As seen in FIG. 6, the prediction 600 may be divided into multiple zones to categorize the predicted probability, for example, a first zone 602 corresponding to a low probability of equipment failure, a second zone 604 corresponding to an intermediate or even probability of equipment failure, and a third zone 606 corresponding to a likely probability of equipment failure.

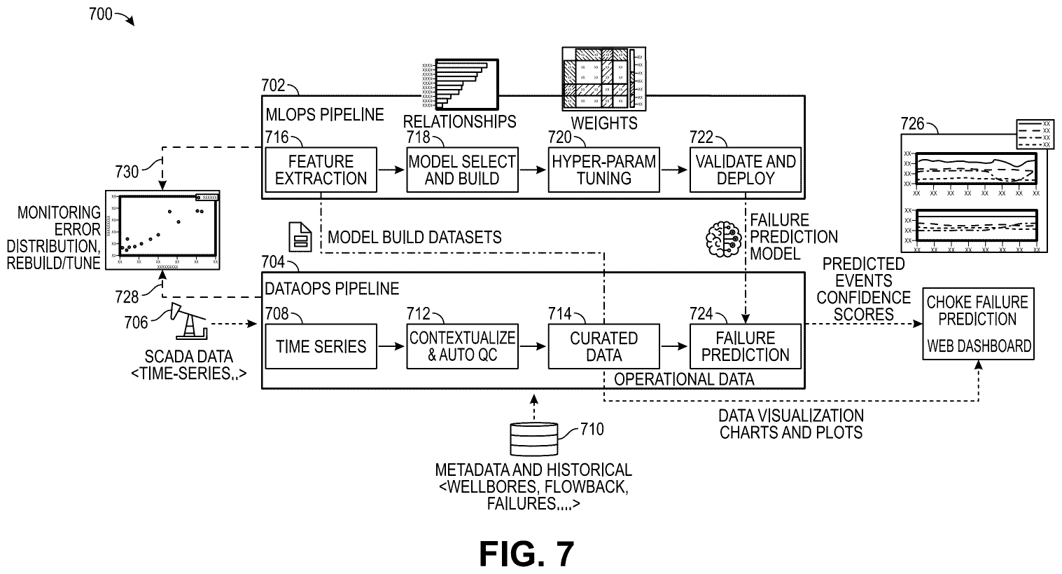

FIG. 7 illustrates one embodiment of a deployment of a method 700 which includes a data science platform or MLOps pipeline 702 and a data gathering platform or DataOps pipeline 704. In certain environments, wellsite or wellbore equipment 706 may send data to the DataOps pipeline 704 in the form of a time series 708. The time series 708 may be contextualized and automatically quality checked as at 712 with the assistance of a database 710 connected to the DataOps pipeline 704 which may provide additional metadata and historical data related to the wellbore such as flowrate data or data related to past equipment failures. After being contextualized as at 712, curated data 714 may be provided which may then be sent to the MLOps pipeline 702 for feature extraction as at 716. In certain embodiments, the extracted features may be used to select or build an appropriate failure prediction model as at 718. In certain embodiments, the building the failure prediction model may include associating the extracted features according to their corresponding relationships. The failure prediction model may be further refined by tuning parameters of the model as at 720. In certain embodiments, the failure prediction model by tuned by adjusting the relative weights of the related model parameters. After being validated, the failure prediction model may be deployed as at 722 which may include deploying the model back to the DataOps pipeline 704. The deployed failure prediction model may then ingest the curated data 714 in order to provide a failure prediction 724. According to certain embodiments, when an error in the obtained data has been detected, such error may be sent from the DataOps pipeline 704 to the MLOps pipeline 702 as at 728 where the failure prediction model may be updated or revised to account for the data error. Similarly, when a parameter of the failure prediction model has become outdated or is no longer relevant for failure prediction purposes, an updated failure prediction model may be prepared and then sent from the MLOps pipeline 702 to the DataOps pipeline 704 as at 730. In this manner, updates may pass between the DataOps pipeline 704 and the MLOps pipeline 702 so that the failure prediction 724 may be kept up to date as circumstances related to the wellsite and wellsite equipment 706 change.

In certain embodiments, the failure prediction 724 may include specific predicted failure events related to the wellsite equipment 706 along with an associated confidence score. In certain embodiments, the failure prediction 724 may be displayed in a graphical interface 726 that is in turn part of a display for a user, for example a web dashboard. In addition to the failure prediction 724, the graphical interface 726 may also include data visualization tools or elements, such as associated charts and plots, which may assist the user in understanding or contextualizing the failure prediction 724. The user may then take mitigating steps in response to the failure prediction 724, for example, repairing or monitoring the wellsite equipment 706, adjusting workflows or other procedures at the wellsite, or appropriate measures.

### Exemplary Method

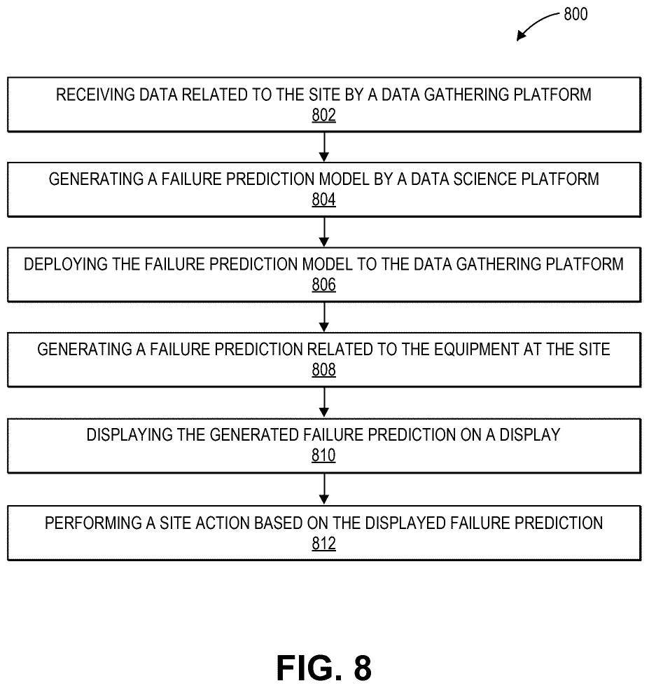

FIG. 8 illustrates a flowchart of a method 800 for predicting equipment failure at a site. An illustrative order of the method 800 is provided below; however, one or more portions of the method 800 may be performed in a different order, simultaneously, repeated, or omitted. At least a portion of the method 800 may be performed by a computing system as further described below.

According to certain embodiments, the method 800 may include receiving data related to the site by a data gathering platform, as at 802. Receiving data related to the site may include receiving flowback data from a database connected to the data gathering platform. In certain embodiments, the flowback data includes data obtained during a formation of a wellbore disposed at the site. In certain embodiments, receiving data related to the site may include receiving real-time data from equipment disposed at the site. In certain embodiments, the real-time data may include a choke opening value, a pressure in the wellbore, a flowrate of hydrocarbons through the wellbore, or a combination thereof.

In certain embodiments, the method 800 may include generating a failure prediction model based on the data by a data science platform, as at 804. Generating the failure prediction model may include cleaning the flowback data, extracting features from the clean flowback data, filtering the extracted features according to how the extracted features affect a failure state of the equipment, and then incorporating the filtered extracted features into the failure prediction model. In certain embodiments, generating the failure prediction model may include cleaning the real-time data, extracting features correlated with a failure state of the equipment from the clean real-time data, filtering the extracted features according to how the how the extracted features affect the failure state of the equipment, and then incorporating the filtered extracted features into the failure prediction model. In certain embodiments, generating the failure prediction model includes generating curated data based on real-time data received from equipment disposed at the site and flowback data received from a database connected to the data gathering platform, and then generating the failure prediction model based on the curated data received from the data gathering platform. In certain embodiments, generating the failure prediction model may include generating at least a first failure prediction model and a second failure prediction model.

According to certain embodiments, the method 800 may include deploying the failure prediction model to the data gathering platform, as at 806. Deploying the failure prediction model may include deploying both the first and second failure prediction models to the data gathering platform.

According to certain embodiments, the method 800 may include generating a failure prediction related to the equipment using the failure prediction model, as at 808. The failure prediction may include an expected average time between consecutive failures, a failure frequency of equipment disposed at the site, or a generated lead-time. The lead-time may include a period of time defined between the generation of the failure prediction and a start of a failure event related to the equipment. In certain embodiments, generating the failure prediction may include generating a first failure prediction by the first failure prediction model and generating a second failure prediction by the second failure prediction model. The first failure prediction may include a probability that equipment disposed at the site may fail within a first time window. The second failure prediction may include a probability that equipment disposed at the site may fail within a second time window. In certain embodiments, generating the first and second failure predictions may include incorporating real-time data received from the equipment into the first and second failure prediction models.

According to certain embodiments, the method 800 may include displaying the generated failure prediction on a display, as at 810.

According to certain embodiments, the method 800 may include performing a site action based on the displayed failure prediction, as at 812. The site action includes generating or transmitting a signal that instructs or causes an action to occur. The action may include a physical action. The physical action may include varying a production of gas or oil from a wellbore, adjusting a flow rate of a gas lift within the wellbore, varying a trajectory of the wellbore, varying a weight or torque on a drill bit that is drilling the wellbore, varying a rate or concentration of a fluid being pumped into the wellbore, replacing, repairing, and maintaining the equipment disposed at the site, or a combination thereof.

### Exemplary Computing System

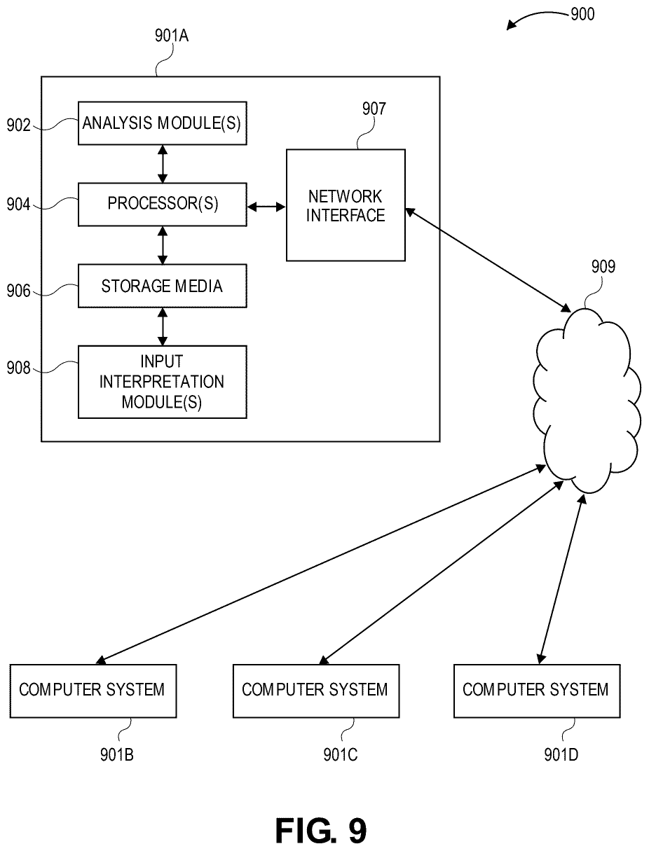

In some embodiments, the methods of the present disclosure may be executed by a computing system. FIG. 9 illustrates an example of such a computing system 900, in accordance with some embodiments. The computing system 900 may include a computer or computer system 901A, which may be an individual computer system 901A or an arrangement of distributed computer systems. The computer system 901A includes one or more analysis modules 902 that are configured to perform various tasks according to some embodiments, such as one or more methods disclosed herein. To perform these various tasks, the analysis module 902 executes independently, or in coordination with, one or more processors 904, which is (or are) connected to one or more storage media 906. The processor(s) 904 is (or are) also connected to a network interface 907 to allow the computer system 901A to communicate over a data network 909 with one or more additional computer systems and/or computing systems, such as 901B, 901C, and/or 901D (note that computer systems 901B, 901C and/or 901D may or may not share the same architecture as computer system 901A, and may be located in different physical locations, e.g., computer systems 901A and 901B may be located in a processing facility, while in communication with one or more computer systems such as 901C and/or 901D that are located in one or more data centers, and/or located in varying countries on different continents).

A processor may include a microprocessor, microcontroller, processor module or subsystem, programmable integrated circuit, programmable gate array, or another control or computing device.

The storage media 906 may be implemented as one or more computer-readable or machine-readable storage media. Note that while in the example embodiment of FIG. 9 storage media 906 is depicted as within computer system 901A, in some embodiments, storage media 906 may be distributed within and/or across multiple internal and/or external enclosures of computing system 901A and/or additional computing systems. Storage media 906 may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories, magnetic disks such as fixed, floppy and removable disks, other magnetic media including tape, optical media such as compact disks (CDs) or digital video disks (DVDs), BLURAY® disks, or other types of optical storage, or other types of storage devices. Note that the instructions discussed above may be provided on one computer-readable or machine-readable storage medium, or may be provided on multiple computer-readable or machine-readable storage media distributed in a large system having possibly plural nodes. Such computer-readable or machine-readable storage medium or media is (are) considered to be part of an article (or article of manufacture). An article or article of manufacture may refer to any manufactured single component or multiple components. The storage medium or media may be located either in the machine running the machine-readable instructions, or located at a remote site from which machine-readable instructions may be downloaded over a network for execution.

In some embodiments, computing system 900 contains one or more input interpretation module(s) 908. In the example of computing system 900, computer system 901A includes the input interpretation module 908. In some embodiments, a single rig safety module may be used to perform some aspects of one or more embodiments of the methods disclosed herein. In other embodiments, a plurality of rig safety modules may be used to perform some aspects of methods herein.

It should be appreciated that computing system 900 is merely one example of a computing system, and that computing system 900 may have more or fewer components than shown, may combine additional components not depicted in the example embodiment of FIG. 9, and/or computing system 900 may have a different configuration or arrangement of the components depicted in FIG. 9. The various components shown in FIG. 9 may be implemented in hardware, software, or a combination of both hardware and software, including one or more signal processing and/or application specific integrated circuits.

Further, the steps in the processing methods described herein may be implemented by running one or more functional modules in information processing apparatus such as general purpose processors or application specific chips, such as ASICs, FPGAs, PLDs, or other appropriate devices. These modules, combinations of these modules, and/or their combination with general hardware are included within the scope of the present disclosure.

Computational interpretations, models, and/or other interpretation aids may be refined in an iterative fashion; this concept is applicable to the methods discussed herein. This may include use of feedback loops executed on an algorithmic basis, such as at a computing device (e.g., computing system 900, FIG. 9), and/or through manual control by a user who may make determinations regarding whether a given step, action, template, model, or set of curves has become sufficiently accurate for the evaluation of the subsurface three-dimensional geologic formation under consideration.

The foregoing description, for purpose of explanation, has been described with reference to specific embodiments. However, the illustrative discussions above are not intended to be exhaustive or limiting to the precise forms disclosed. Many modifications and variations are possible in view of the above teachings. Moreover, the order in which the elements of the methods described herein are illustrate and described may be re-arranged, and/or two or more elements may occur simultaneously. The embodiments were chosen and described in order to best explain the principles of the disclosure and its practical applications, to thereby enable others skilled in the art to best utilize the disclosed embodiments and various embodiments with various modifications as are suited to the particular use contemplated.

What is claimed is:

1. A method for predicting equipment failure at a site, the method comprising:
receiving data related to the site by a data gathering platform;
generating a failure prediction model based on the data by a data science platform;
deploying the failure prediction model to the data gathering platform;
generating a failure prediction related to the equipment using the failure prediction model; and
displaying the generated failure prediction on a display.

2. The method of claim 1, wherein receiving data related to the site comprises receiving flowback data from a database connected to the data gathering platform.

3. The method of claim 2, wherein the flowback data comprises data obtained during a formation of a wellbore disposed at the site.

4. The method of claim 2, wherein generating the failure prediction model comprises:
cleaning the flowback data;
extracting features from the clean flowback data;
filtering the extracted features according to how the extracted features affect a failure state of the equipment; and
incorporating the filtered extracted features into the failure prediction model.

5. The method of claim 1, wherein receiving data related to the site comprises receiving real-time data from equipment disposed at the site.

6. The method of claim 5, wherein the real-time data comprises a choke opening value, a pressure in a wellbore, a flowrate of hydrocarbons through the wellbore, or a combination thereof.

7. The method of claim 5, wherein generating the failure prediction model comprises:
cleaning the real-time data;
extracting features correlated with a failure state of the equipment from the clean real-time data;
filtering the extracted features according to how the extracted features affect the failure state of the equipment; and
incorporating the filtered extracted features into the failure prediction model.

8. The method of claim 1, wherein the failure prediction comprises an expected average time between consecutive failures or a failure frequency of equipment disposed at the site.

9. The method of claim 1, wherein the failure prediction comprises a generated lead-time, wherein the lead-time comprises a period of time defined between the generation of the failure prediction and a start of a failure event related to the equipment.

10. The method of claim 1, further comprising performing a site action based on the displayed failure prediction.

11. A computing system, comprising:
one or more processors; and
a memory system comprising one or more non-transitory computer-readable media storing instructions that, when executed by at least one of the one or more processors, cause the computing system to perform operations, the operations comprising:
receiving data related to a site by a data gathering platform;
generating a failure prediction model based on the data by a data science platform;
deploying the failure prediction model to the data gathering platform;
generating a failure prediction related to equipment using the failure prediction model; and
displaying the generated failure prediction on a display.

12. The computing system of claim 11, wherein generating the failure prediction model comprises generating curated data based on real-time data received from equipment disposed at the site and flowback data received from a database connected to the data gathering platform.

13. The computing system of claim 12, wherein generating the failure prediction model comprises generating the failure prediction model based on the curated data received from the data gathering platform.

14. The computing system of claim 11, wherein generating the failure prediction model comprises generating at least a first failure prediction model and a second failure prediction model.

15. The computing system of claim 14, wherein deploying the failure prediction model comprises deploying both the first and second failure prediction models to the data gathering platform.

16. The computing system of claim 14, wherein generating the failure prediction comprises generating a first failure prediction by the first failure prediction model and generating a second failure prediction by the second failure prediction model.

17. The computing system of claim 16, wherein the first failure prediction comprises a probability that equipment disposed at the site may fail within a first time window and wherein the second failure prediction comprises a probability that equipment disposed at the site may fail within a second time window.

18. The computing system of claim 16, wherein generating the first and second failure predictions comprise incorporating real-time data received from the equipment into the first and second failure prediction models.

19. The computing system of claim 11, wherein the operations further comprise performing a site action based on the displayed failure prediction, wherein the site action comprises generating or transmitting a signal that instructs or causes an action to occur, wherein the action comprises a physical action, and wherein the physical action comprises varying a production of gas or oil from a wellbore, adjusting a flow rate of a gas lift within the wellbore, varying a trajectory of the wellbore, varying a weight or torque on a drill bit that is drilling the wellbore, varying a rate or concentration of a fluid being pumped into the wellbore, replacing, repairing, and maintaining the equipment disposed at the site, or a combination thereof.

20. A non-transitory computer-readable medium storing instructions that, when executed by one or more processors of a computing system, cause the computing system to perform operations, the operations comprising:
receiving data related to a site by a data gathering platform;
generating a failure prediction model based on the data by a data science platform;
deploying the failure prediction model to the data gathering platform;
generating a failure prediction related to equipment using the failure prediction model; and
displaying the generated failure prediction on a display.
